(19) United States
(12) Patent Application Publication
(10) Pub. No.: US 2015/0111069 A1
(43) Pub. Date: Apr. 23, 2015

(54) SECONDARY BATTERY MODULE

(71) Applicant: SAMSUNG SDI CO., LTD., Yongin-si (KR)

(72) Inventors: Minyeol Han, Yongin-si (KR); Sangwon Byun, Yongin-si (KR); Jeongwon Oh, Yongin-si (KR); Zin Park, Yongin-si (KR)

(73) Assignee: SAMSUNG SDI CO., LTD., Yongin-si (KR)

(21) Appl. No.: 14/181,615

(22) Filed: Feb. 14, 2014

(30) Foreign Application Priority Data
Oct. 21, 2013 (KR) 10-2013-0125383

(51) Int. Cl. H01M 2/34; H01M 2/12

(52) U.S. Cl. CPC H01M 2/345; H01M 2/1241; H01M 2200/20
USPC 429/7

(57) ABSTRACT

A secondary battery module includes a plurality of secondary batteries arranged in parallel with each other, each of the plurality of secondary batteries including an electrode assembly, a case accommodating the electrode assembly, first and second electrode terminals electrically coupled to the electrode assembly, and a short circuit member electrically coupled to the first electrode terminal and configured to protrude towards outside of the case when an internal pressure in the case increases, a plurality of first connection members coupling the plurality of secondary batteries to each other in series, and a second connection member having one side facing a short circuit member of one of the plurality of secondary batteries and an other side electrically coupled to a second electrode terminal of a secondary battery arranged at a last position from among the plurality of secondary batteries.

### CROSS-REFERENCE TO RELATED APPLICATION

This application claims priority to and the benefit of Korean Patent Application No. 10-2013-0125383, filed on Oct. 21, 2013 in the Korean Intellectual Property Office, the disclosure of which is incorporated in its entirety herein by reference.

### BACKGROUND

1. Field

Embodiments of the present invention relate to a secondary battery module.

2. Description of the Related Art

A secondary battery module may include a plurality of secondary batteries coupled in series as unit cells. Each of the unit cells may include an electrode assembly having a separator, as an insulator, disposed between positive and negative electrode plates, a case having a space in which the electrode assembly is housed, a cap assembly coupled to the case and sealing the case, and positive and negative electrode terminals protruding from the cap assembly and electrically coupled to positive and negative electrode current collectors provided in the electrode assembly.

Meanwhile, each of the unit cells may have a membrane and a fuse installed and electrically coupled to the positive electrode terminal. The membrane makes contact with the negative electrode terminal when an internal pressure of the case increases due to, for example, overcharging of the unit cell, thereby short circuiting the positive and negative electrodes to each other. The fuse is severed or melts due to the short circuiting, thereby blocking an electrical connection in the unit cell.

However, the membrane is highly vulnerable to malfunction. Even during normal operation, most of the unit cells included in the secondary battery module may be unavoidably or unintentionally damaged.

In addition, because the membrane is often welded to a peripheral portion of an opening (e.g., hole) formed in the case, moisture may easily penetrate into a welded part of the membrane. Accordingly, the welded part of the membrane may be susceptible to corrosion.

### SUMMARY

Aspects of embodiments of the present invention provide a secondary battery module which prevents or reduces corrosion by preventing damage from being caused to unit cells and by preventing moisture from penetrating into the unit cells during overcharge.

According to at least one embodiment, a secondary battery module includes a plurality of secondary batteries arranged in parallel, each of the plurality of second batteries including an electrode assembly, a case accommodating the electrode assembly, first and second electrode terminals electrically coupled to the electrode assembly, and a short circuit member electrically coupled to the first electrode terminal and configured to protrude towards outside of the case when an internal pressure in the case increases, a plurality of first connection members coupling the plurality of secondary batteries to each other in series, and a second connection member having one side facing a short circuit member of one of the plurality of secondary batteries and an other side electrically coupled to a second electrode terminal of a secondary battery arranged at a last position from among the plurality of secondary batteries.

The secondary battery module may further include an insulation film covering top surfaces of the plurality of secondary batteries and having an opening above the short circuit member.

Each of the plurality of secondary batteries may further include a safety vent covered by the insulation film and configured to open when the internal pressure in the case increases.

When the safety vent opens, the insulation film may be ruptured by the safety vent to be open.

The secondary battery module may further include a gas guiding member on the plurality of secondary batteries and configured to guide gases exhausted from the plurality of secondary batteries.

The gas guiding member may include a first plate facing and spaced from the top surfaces of the plurality of secondary batteries, and a second plate and a third plate extending from opposite side ends of the first plate and are between the first and second electrode terminals of the plurality of secondary batteries, and other opposite sidewalls of the gas guiding member are open.

The gas guiding member may include an insulating material.

The short circuit member may be configured to deform to contact one side of the second connection member when the internal pressure in the case increases.

The secondary battery module may further include a fuse electrically coupling the electrode assembly and the first electrode terminal.

The short circuit member may be at a secondary battery arranged at a first position from among the plurality of secondary batteries.

According to an other embodiment, a secondary battery module includes a plurality of secondary batteries arranged in parallel, each of the plurality of secondary batteries including an electrode assembly, a case accommodating the electrode assembly, first and second electrode terminals electrically coupled to the electrode assembly, and a short circuit member electrically coupled to the first electrode terminal and configured to protrude towards outside of the case when an internal pressure in the case increases; a plurality of first connection members coupling the plurality of secondary batteries to each other in series; and a second connection member on the plurality of secondary batteries and including a short circuit plate facing a short circuit member of one of the plurality of secondary batteries, a connection plate electrically coupled to a second electrode terminal of a secondary battery arranged at a last position from among the plurality of secondary batteries, and a gas guiding member configured to guide gases exhausted from the plurality of secondary batteries.

The secondary battery module may further include an insulation film covering top surfaces of the plurality of secondary batteries and having an opening above the short circuit member.

Each of the plurality of secondary batteries may further include a safety vent covered by the insulation film and configured to open when the internal pressure in the case increases.

The insulation film may be configured to be ruptured by the safety vent to be open when the safety vent opens.

The gas guiding member may include a first plate facing and spaced from top surfaces of the plurality of secondary batteries, and a second plate and a third plate extending from opposite side ends of the first plate and between the first and second electrode terminals of the plurality of secondary batteries, and other opposite sidewalls of the gas guiding member are open.

The secondary battery module may further include an insulation member between each bottom surface of the second plate and the third plate and each of the top surfaces of the plurality of secondary batteries.

The short circuit plate and the connection plate may be coupled to the second plate or the third plate.

When the internal pressure in the case increases, the short circuit member may deform to contact one side of the short circuit plate.

The secondary battery module may further include a fuse electrically coupling the electrode assembly and the first electrode terminal.

The short circuit member may be at a secondary battery arranged at a first position from among the plurality of secondary batteries.

As described above, embodiments of the present invention provide a secondary battery module which undergoes reduced or minimized corrosion by preventing damage from being caused to unit cells and by preventing moisture from penetrating into the unit cells during overcharge.

### BRIEF DESCRIPTION OF THE DRAWINGS

The accompanying drawings are included to provide a further understanding of the present disclosure, and are incorporated in and constitute a part of this specification. The drawings illustrate example embodiments of the present disclosure and, together with the description, serve to explain principles of the present disclosure. In the drawings:

FIG. 1 is an exploded perspective view of a secondary battery module according to an example embodiment of the present invention;

FIG. 2 is a perspective view illustrating a connection mechanism of the secondary battery module shown in FIG. 1;

FIG. 3 is a cross-sectional view of the secondary battery module, taken along the line I-I′ of FIG. 2;

FIG. 4 is an exploded perspective view of a secondary battery module according to another example embodiment of the present invention;

FIG. 5 is a perspective view illustrating a connection mechanism of the secondary battery module shown in FIG. 4;

FIG. 6 illustrates a top surface, a front surface, a rear surface, a left side surface, and a right side surface of a second connection member shown in FIG. 4; and

FIG. 7 is a cross-sectional view of the secondary battery module, taken along the line II-II′ of FIG. 5.

### DETAILED DESCRIPTION

It will be understood that when an element such as a layer, film, region, or substrate is referred to as being “on” another element, it can be directly on the other element or intervening elements may also be present. When an element is referred to as being “directly on” another element, there are no intervening elements present. Expressions such as “at least one of,” when preceding a list of elements, modify the entire list of elements and do not modify the individual elements of the list. Further, the use of “may” when describing embodiments of the present invention refers to “one or more embodiments of the present invention.”

Example embodiments will now be described more fully hereinafter with reference to the accompanying drawings.

First, a secondary battery module according to an embodiment of the present invention will be described in detail.

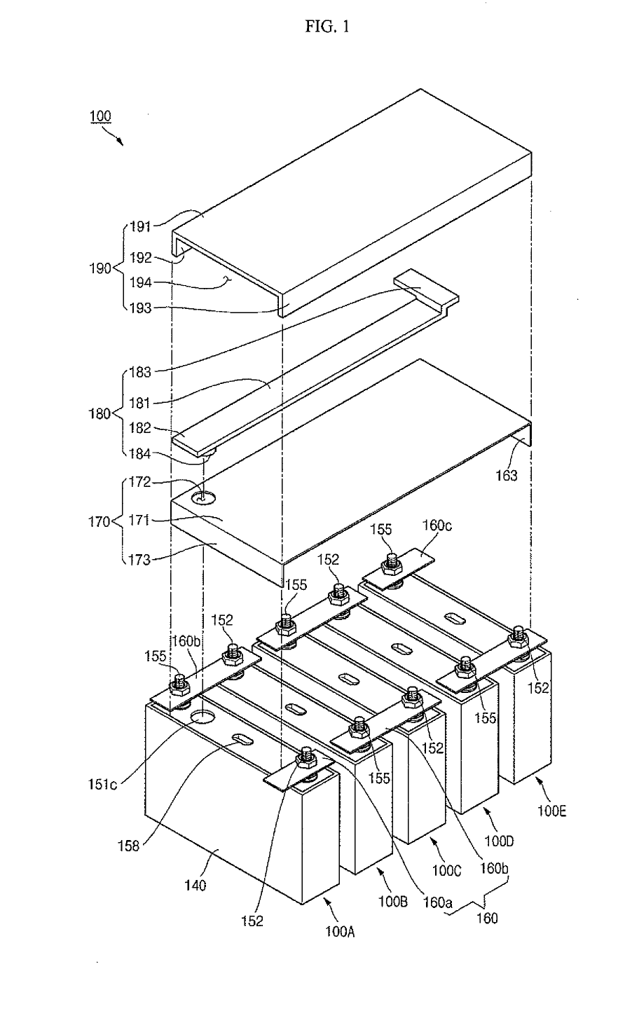

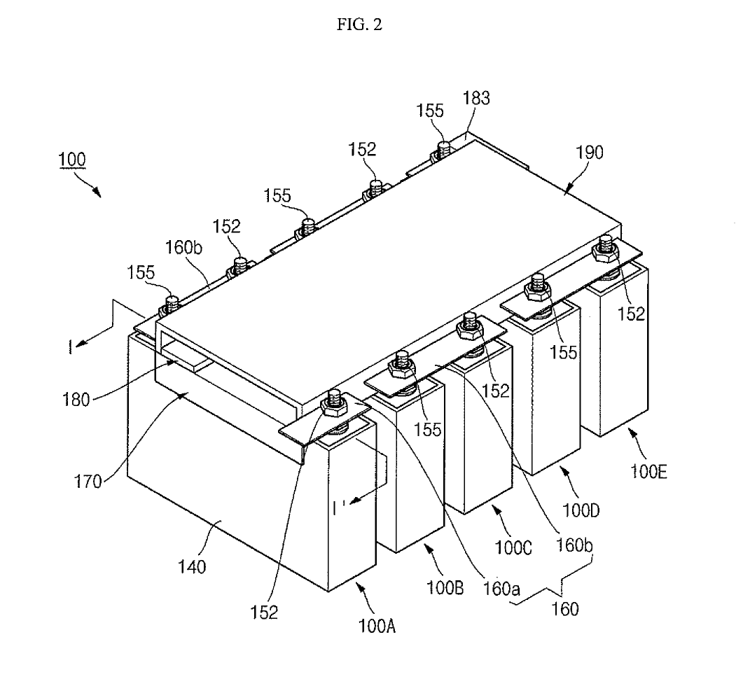

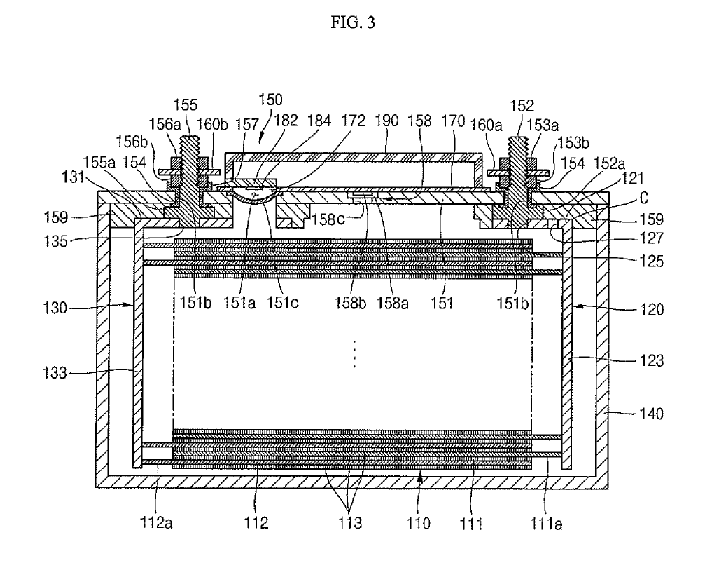

FIG. 1 is an exploded perspective view of a secondary battery module according to an embodiment of the present invention, FIG. 2 is a perspective view illustrating a connection mechanism of the secondary battery module shown in FIG. 1, and FIG. 3 is a cross-sectional view of the secondary battery module, taken along the line I-I′ of FIG. 2.

Referring to FIGS. 1 to 3, the secondary battery module 100 according to an embodiment of the present invention includes a plurality of secondary batteries, first connection members 160, and a second connection member 180. In addition, the secondary battery module 100 may further include an insulation film 170 and a gas guiding member 190.

The plurality of secondary batteries may include first to fifth unit cells 100A, 100B, 100C, 100D, and 100E arranged to be parallel to each other. For example, as shown in FIG. 1, the first unit cell 100A may be arranged at a first place or position, the second unit cell 100B may be arranged at a second place or position, the third unit cell 100C may be arranged at a third place or position, the fourth unit cell 100D may be arranged at a fourth place or position, and the fifth unit cell 100E may be arranged at a last place or position. The arrangement order is defined on the basis of a direction of the flowing current when the secondary battery module 100 is charged. That is to say, when the secondary battery module 100 is charged, the aforementioned arrangement order is defined according to the direction of the current flowing from the first unit cell 100A to the second unit cell 1008, the third unit cell 100C, the fourth unit cell 100D, and to the fifth unit cell 100E.

In the embodiment of the present invention, the number of unit cells is defined as five, but aspects of the present invention are not limited thereto. At least three unit cells may be appropriately provided.

Because the first to fifth unit cells 100A, 100B, 100C, 100D, and 100E have substantially the same or the same configuration, the first unit cell 100A will be representatively described in detail in the following description.

The first unit cell 100A may include an electrode assembly 110, a first current collector 120, a second current collector 130, a case 140, and a cap assembly 150.

The electrode assembly 110 may be formed by winding or laminating a stack including a first electrode plate 111, a separator 113, and a second electrode plate 112, which are thin plates or layers. Here, the first electrode plate 111 may function as a positive electrode, and the second electrode plate 112 may function as a negative electrode.

The first electrode plate 111 may be formed by coating a first electrode active material, e.g., a transition metal oxide, on a first current collector made of a metal foil, e.g., aluminum foil. The first electrode plate 111 may include a first uncoated portion 111a (that is, a portion not coated with the first electrode active material). The first uncoated portion 111a may correspond to a path of current flow between the first electrode plate 111 and outside of the first electrode plate 111. Meanwhile, the present invention does not limit the materials of the first electrode plate 111 to those listed herein.

The second electrode plate 112 may be formed by coating a second electrode active material, e.g., graphite or carbon, onto a second current collector made of a metal foil, e.g., nickel or copper. The second electrode plate 112 may include a second uncoated portion 112a (that is, a portion not coated with the second electrode active material). The second uncoated portion 112a may correspond to a path of current flow between the second electrode plate 112 and outside of the second electrode plate 112. Meanwhile, the present invention does not limit the materials of the second electrode plate 112 to those listed herein.

The separator 113, located between the first and second electrode plates 111 and 112, may prevent short circuits between the first and second electrode plates 111 and 112, and may allow lithium ions to freely move. The separator 113 may be made of, for example, polyethylene, polypropylene, or a composite film including polyethylene and polypropylene. Meanwhile, the present invention does not limit the material of the separator 113 to those listed herein.

The first current collector 120 and the second current collector 130 may be coupled to opposite ends of the electrode assembly 110 to be electrically coupled to (e.g., electrically connected to) the first and second electrode plates 111 and 112, respectively.

The first current collector 120 may be formed of a conductive material, such as aluminum or an aluminum alloy, and may contact the first electrode uncoated portion 111a protruding from one end of the electrode assembly 110 to be electrically coupled to (e.g., electrically connected to) the first electrode plate 111. The first current collector 120 may include a first coupling part 121 and a first extension part 123. A first terminal opening 125 (e.g., a first terminal hole) and a fuse opening 127 (e.g., a fuse hole) may be formed in the first coupling part 121. The first terminal opening 125 may provide a space into which a first electrode terminal 152 is inserted and coupled. The fuse opening 127 may be configured such that a peripheral region (e.g., a perimeter region) around the fuse opening 127 has a smaller sectional area than other regions of the first coupling part 121. The first extension part 123 is bent and extended from an end of the first coupling part 121, is shaped as a plate, and substantially contacts the first electrode uncoated portion 111a. Assuming that a corner at which the first coupling part 121 and the first extension part 123 meet is denoted by “C”, the first coupling part 121 and the first extension part 123 may be substantially perpendicular to each other about the corner C.

The second current collector 130 may be formed of a conductive material, such as copper, a copper alloy, nickel, or a nickel alloy, and may contact the second electrode uncoated portion 112a protruding from the other end of the electrode assembly 110 to be electrically coupled to (e.g., electrically connected to) the second electrode plate 112. The second current collector 130 may include a second coupling part 131 and a second extension part 133. A second terminal opening 135 (e.g., a second terminal hole) may be formed in the second coupling part 131. The second terminal opening 135 may provide a space into which a second electrode terminal 155 is inserted and coupled. The second extension part 133 is bent and extended from an end of the second coupling part 131, is shaped as a plate, and substantially contacts the second electrode uncoated portion 112a. The second coupling part 131 and the second extension part 133 may be perpendicular to each other about a corner at which they meet.

The case 140 may be formed of a conductive metal, such as aluminum, an aluminum alloy, or a nickel plated steel and may have an approximately hexahedron shape provided with an opening (e.g., a case opening) through which the electrode assembly 110, the first collector plate 120, and the second collector plate 130 are inserted and placed. Because the case 140 and the cap assembly 150 are illustrated in an assembled state in FIGS. 1 to 3, the case opening is not shown. However, it is to be understood that the case opening corresponds to a substantially opened portion of the edge of the cap assembly 150. The inner surface of the case 140 may be treated to be insulated from the electrode assembly 110, the first and second collector plates 120 and 130, and the cap assembly 150. Here, the case 140 may be electrically coupled to (e.g., electrically connected to) the first electrode terminal 152 and may function as a positive electrode (e.g., may be positively biased), for example.

The cap assembly 150 may be coupled to the case 140. For example, the cap assembly 150 may be coupled to the case opening. The cap assembly 150 may include a cap plate 151, a first electrode terminal 152, first nuts 153a and 153b, a first gasket 154, a second electrode terminal 155, second nuts 156a and 156b, a second gasket 157, a safety vent 158, and an insulation member 159.

The cap plate 151 may be coupled to the case opening to close the opening of the case 140. A short circuit opening 151a (e.g., a short circuit hole), terminal openings 151b (e.g., terminal holes), a short circuit member 151c, and a safety vent 158 may be formed in the cap plate 151. Here, the terminal openings 151b may be formed at one side and the other side of the cap plate 151 (e.g., at opposite sides of the cap plate 151), respectively. The cap plate 151 may be formed of the same material as that of the case 140 and may have the same polarity as that of the case 140.

The short circuit member 151c is installed in the short circuit opening 151a of the cap plate 151 and has the same polarity as that of the cap plate 151. The short circuit member 151c may include an inversion plate having a downwardly convex round part and an edge part (e.g., a substantially flat edge part) fixed to the short circuit opening 151a. Here, a peripheral part of the short circuit opening 151a is formed stepwise (e.g., is formed to have a step), and the edge part of the short circuit member 151c is placed in the stepped peripheral part of the short circuit opening 151a and then coupled to the cap plate 151 by, for example, welding. When the internal pressure of the first unit cell 100A exceeds a reference pressure (e.g., a preset or predetermined pressure), the short circuit member 151c may be inverted (e.g., may deform) to then upwardly convexly protrude. The short circuit member 151c may be formed in each of the first to fifth unit cells 100A, 100B, 100C, 100D, and 100E. An example embodiment of the present invention will be described in which the short circuit member 151c is formed only in the first unit cell 100A arranged at the first position.

The first electrode terminal 152, passing through the terminal opening 151b formed at one side of the cap plate 151, may be electrically coupled to (e.g., electrically connected to) the first current collector 120. The first electrode terminal 152 may be shaped as a pillar. A screw thread is formed at the outer circumferential edge of an upper pillar exposed to an upper portion of the cap plate 151, and a flange 152a is formed at a lower pillar positioned at a lower portion of the cap plate 151 to prevent the first electrode terminal 152 from being dislodged from the cap plate 151. In the first electrode terminal 152, a portion of the lower pillar positioned at a lower portion of the cap plate 151 may be fitted into the terminal opening 125 of the first current collector 120. The first electrode terminal 152 may be electrically coupled to (e.g., electrically connected to) the cap plate 151 such that a top surface of the flange 152a makes contact with the cap plate 151.

First nuts 153a and 153b include a first upper nut 153a and a first lower nut 153b, which are fastened along the screw thread formed on the first electrode terminal 152, thereby fixing the first electrode terminal 152 to the cap plate 151.

The first gasket 154 may be formed of an insulating material and may be disposed between the first electrode terminal 152 and the cap plate 151 to seal a space between the first electrode terminal 152 and the cap plate 51. The first gasket 154 may prevent the penetration of moisture into the first unit cell 100A or the leakage of the electrolyte from the first unit cell 100A.

The second electrode terminal 155, passing through the terminal opening 151b formed at the other side of the cap plate 151, may be electrically coupled to (e.g., electrically connected to) the second current collector 130. The electrode terminal 155 may be shaped as a pillar. A screw thread is formed at the outer circumferential edge of the upper pillar exposed to an upper portion of the cap plate 151, and a flange 155a is formed at the lower pillar positioned at the lower portion of the cap plate 151 to prevent the second electrode terminal 155 from being dislodged from the cap plate 151. In the second electrode terminal 155, a portion of the lower pillar positioned at the lower portion of the cap plate 151 may be fitted into the terminal opening 135 of the second current collector 130. The second electrode terminal 155 may be electrically insulated from the cap plate 151.

Second nuts 156a and 156b include a second upper nut 156a and a second lower nut 156b, which are fastened along the screw thread formed on the second electrode terminal 155, thereby fixing the second electrode terminal 155 to the cap plate 151.

The second gasket 157 may be formed of an insulating material and may be disposed between the second electrode terminal 155 and the cap plate 151 to seal a space between the second electrode terminal 155 and the cap plate 51. The second gasket 157 may prevent the penetration of moisture into the first unit cell 100A or the leakage of the electrolyte from the first unit cell 100A.

The safety vent 158 may be formed in a vent opening 158c (e.g., a vent hole) of the cap plate 151 and may include a vent plate 158a. The vent plate 158a may have a notch 158a configured to be opened when the internal pressure of the case 140 increases. Here, when the internal pressure of the case 140 exceeds a reference pressure (e.g., a preset or predetermined pressure), the vent plate 158a ruptures along the notch 158b and the ruptured part of the vent plate 158a opens to face a top portion of the cap plate 151.

The insulation member 159 may be installed between each of the first and second current collectors 120 and 130 and the cap plate 151 to prevent unnecessary or unintended short circuiting thereof.

The first connection member 160 electrically couples (e.g., electrically connects) electrode terminals of neighboring cells among the first to fifth unit cells 100A, 100B, 100C, 100D, and 100E to each other, thereby coupling (e.g., connecting) the first to fifth unit cells 100A, 100B, 100C, 100D, and 100E to each other in series.

The first connection member 160 may include a first-first connection member 160a, a plurality of first-second connection members 160b, and a first-third connection member 160c. The first-first connection member 160a may be coupled to (e.g., connected to) the first electrode terminal 152 of the first unit cell 100A. The plurality of first-second connection members 160b may couple (e.g., connect) the second electrode terminal 155 of the first unit cell 100A and the first electrode terminal 152 of the second unit cell 1008, the second electrode terminal 155 of the second unit cell 100B and the first electrode terminal 152 of the third unit cell 100C, the second electrode terminal 155 of the third unit cell 100C and the first electrode terminal 152 of the fourth unit cell 100D, and the second electrode terminal 155 of the fourth unit cell 100D and the first electrode terminal 152 of the fifth unit cell 100E. The first-third connection member 160c may be coupled to (e.g., connected to) the second electrode terminal 155 of the fifth unit cell 100E.

As shown in FIG. 3, the first-first connection member 160a may be placed on (e.g., inserted into) the first electrode terminal 152 and may be coupled to the first electrode terminal 152 by the first upper and lower nuts 153a and 153b. The first-second connection members 160b may also be placed on (e.g., inserted into) the second electrode terminal 155 and may be coupled to the second electrode terminal 155 by the second upper and lower nuts 156a and 156b.

The insulation film 170 may include a first film part 171 and a second film part 173.

The first film part 171 may be formed to cover top surfaces of the first to fifth unit cells 100A, 100B, 100C, 100D, and 100E. For example, the first film part 171 may cover the top surfaces of the first to fifth unit cells 100A, 100B, 100C, 100D, and 100E, particularly the safety vent 158 (e.g., the safety vent 158 of each of the first to fifth unit cells 100A, 100B, 100C, 100D, and 100E), except for the first and second electrode terminals 152 and 155 and the first connection members 160 (that is, the first film part 171 may not cover the first and second electrode terminals 152 and 155 of each of the first to fifth unit cells 100A, 100B, 100C, 100D, and 100E). However, the first film part 171 has an opening 172 (e.g., an opening hole) facing (e.g., corresponding to) the short circuit member 151c, thereby opening or exposing a top portion of the short circuit member 151c through the opening 172.

The second film part 173, which is connected to (e.g., connected to and extends from) opposite ends of the first film part 171, may cover portions of upper side surfaces of the first unit cell 100A and the fifth unit cell 100E.

One example embodiment of the present invention has been described in which the short circuit member 151c is formed only in the first unit cell 100A. However, the short circuit member 151c may be formed in all of the unit cells 100A, 1008, 100C, 100D, and 100E. In this case, the insulation film 170 may open or expose only the short circuit member 151c formed in the first unit cell 100A and may cover the remaining short circuit members. In this case, the insulation film 170 covers all of the remaining short circuit members, thereby preventing moisture from penetrating through contacting (e.g., connected) portions of the short circuit members and the cap plate. In addition, a peripheral portion of the opening 172 of the insulation film 170 covers a peripheral portion of the short circuit member 151c, thereby effectively preventing moisture penetration therethrough. In addition, when one surface of the insulation film 170 is an adhesive surface, the insulation film 170 is brought into closer contact (e.g., more secure contact) with the top surfaces of the first to fifth unit cells 100A, 100B, 100C, 100D, and 100E, thereby further preventing moisture from penetrating into the peripheral portion of the short circuit member 151c.

The insulation film 170 is formed to have a thickness (e.g., an appropriate or predetermined thickness) so as to be torn out and opened (e.g., ruptured) when the safety vent 158 ruptures. The insulation film 170 may be made of a material having heat resistance characteristics so as not melt even when a surface temperature of the battery rises.

The second connection member 180 may have a body part 181, one side part 182, and an other side part 183.

The body part 181 has a length so as to traverse the top portions of the first to fifth unit cells 100A, 1008, 100C, 100D, and 100E arranged in parallel to each other. The body part 181 may be substantially shaped as a bar extending from the short circuit member 151 c of the first unit cell 100A toward or to the second electrode terminal 155 of the fifth unit cell 100E.

The one side part 182 faces the short circuit member 151c of the first unit cell 100A and may have a protrusion 184 formed on its bottom surface to protrude toward the short circuit member 151c. When the short circuit member 151c operates so that the short circuit member 151c protrudes toward the top portion of the cap plate 151, the short circuit member 151c may be electrically coupled with (e.g., may electrically contact) the second connection member 180 (e.g., the protrusion 184 of the second side part 182).

The other side part 183 is substantially vertically bent from the body part 181 and extends toward the second electrode terminal 155 of the fifth unit cell 100E. The other side part 183 may be substantially shaped as a plate extending to have a height (e.g., to have a predetermined height) from a top surface of the body part 181. The other side part 183 may be electrically coupled to (e.g., electrically connected to) the second electrode terminal 155 of the fifth unit cell 100E.

Therefore, when the short circuit member 1510 operates so that it contacts the second connection member 180, a current may bypass to directly couple (e.g., directly connect) the short circuit member 151c of the first unit cell 100A and the second electrode terminal 155 of the fifth unit cell 100E (that is, the current may bypass the second to fifth unit cells 100B, 100C, 100D, and 100E).

The gas guiding member 190 may be shaped as a substantially “U” shaped duct and may serve to guide gases discharged from the first to fifth unit cells 100A, 100B, 100C, 100D, and 100E in a direction (e.g., a constant or predetermined direction).

For example, the gas guiding member 190 may include first to third plates 191, 192, and 193. The first plate 191 may face and may be spaced from (e.g., spaced apart from) the first to fifth unit cells 100A, 100B, 100C, 100D, and 100E. The second and third plates 192 and 193 may be connected to (e.g., extend from) opposite ends of the first plate 191 and be above each of the top surfaces of the first to fifth unit cells 100A, 1008, 100C, 100D and 100E (e.g., each of the second and third plates 192 and 193 may be between the first and second electrode terminals 152 and 155 of the first to fifth unit cells 100A, 1008, 100C, 100D, and 100E), thereby forming opposite sidewalls of the gas guiding member 190. The second plate 192 of the gas guiding member 190 may be placed on (e.g., located on or contacting) the second connection member 180, and a third plate 193 may be placed on (e.g., located on or contacting) the insulation film 170. The opposite sidewalls of the gas guiding member 190, that is, the second and third plates 192 and 193, as shown in FIG. 1, may be sidewalls facing the first and second electrode terminals 152 and 155. In addition, other opposite side surfaces of the gas guiding member 190 may be opened to form an exhaust opening 194 (e.g., exhaust hole) through which gases are released or exhausted. The gas guiding member 190 may include an insulating material.

Next, an operation of the secondary battery module 100 according to an embodiment of the present invention when the secondary battery module 100 is overcharged will be described.

When the first to fifth unit cells 100A, 100B, 100C, 100D, and 100E are overcharged, the internal pressure of each of cases of the first to fifth unit cells 100A, 100B, 100C, 100D, and 100E increases due to the gases released from each of electrode assemblies of the first to fifth unit cells 100A, 1008, 100C, 100D, and 100E. When the internal pressure exceeds a reference pressure (e.g., a preset or predetermined pressure), the short circuit member 151c of the first unit cell 100A, arranged at the first position among the first to fifth unit cells 100A, 100B, 100C, 100D, and 100E, is inverted to protrude toward the top portion of the cap plate 151. Here, the protruding short circuit member 151c electrically contacts the one side part 182 of the second connection member 180 (or electrically contacts the protrusion 184 of the one side part 182 of the second connection member 180, if present) so that the short circuit member 151c is electrically coupled to (e.g., electrically connected to) the second electrode terminal 155 of the fifth unit cell 100E, arranged at the last position, through the second connection member 180.

When the secondary battery module 100 is normally charged, a current flows in sequence from the first electrode terminal 152 of the first unit cell 100A, arranged at the first position to the first to fifth unit cells 100A, 1008, 100C, 100D, and 100E, through the second electrode terminal 155 of the fifth unit cell 100E. However, when the secondary battery module 100, according to the embodiment of the present invention, is overcharged, a resulting over-current bypasses and flows through the first electrode terminal 152 of the first unit cell 100A, arranged at the first position, to the case 140 of the first unit cell 100A, to the short circuit member 151c, to the second connection member 180, and then to the second electrode terminal 155 of the fifth unit cell 100E, arranged at the last position. Accordingly, only the fuse 127 of the first unit cell 100A is melted and severed, thereby blocking an electrical connection between the secondary battery module 100 and an external device.

When an overcharge occurs in a state in which the second connection member 180 is not provided, such as in a comparative secondary battery module, over-current flows through each of the first to fifth unit cells 100A, 1008, 100C, 100D, and 100E until one of fuses of the respective unit cells melts and is severed. In this case, even if there are unit cells whose fuses are not melted or severed, short circuit members corresponding to these unit cells may partially operate so that at least portions of the fuses are melted, thereby making the unit cells severely damaged so as not to be recyclable or reusable.

However, according to an embodiment of the present invention, during overcharge, over-current does not flow through the second to fifth unit cells 1008, 100C, 100D, and 100E; over-current only flows through the first unit cell 100A arranged at the first position, thereby preventing the other unit cells from being unnecessarily damaged.

In addition, because an over-current is bypassed during overcharge, it is not necessary to provide a safety device, such as a short circuit member, in the unit cell or unit cells through which an over-current does not flow. Accordingly, the component cost of the secondary battery module may be reduced. In addition, because the short circuit member is not provided, it is possible to nullify a probability of moisture penetration into a portion at which the short circuit member is installed. Further, in a case where the short circuit member is installed, moisture penetration into the portion of the short circuit member can be reduced or minimized by the insulation film 170.

Hereinafter, a secondary battery module according to another embodiment of the present invention will be described in detail.

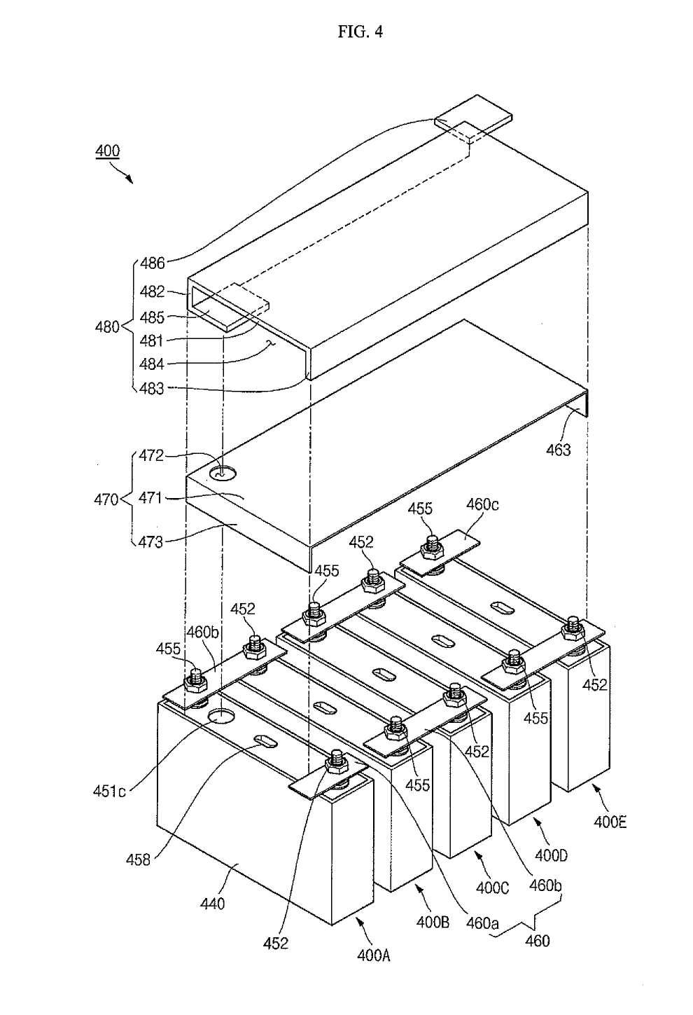

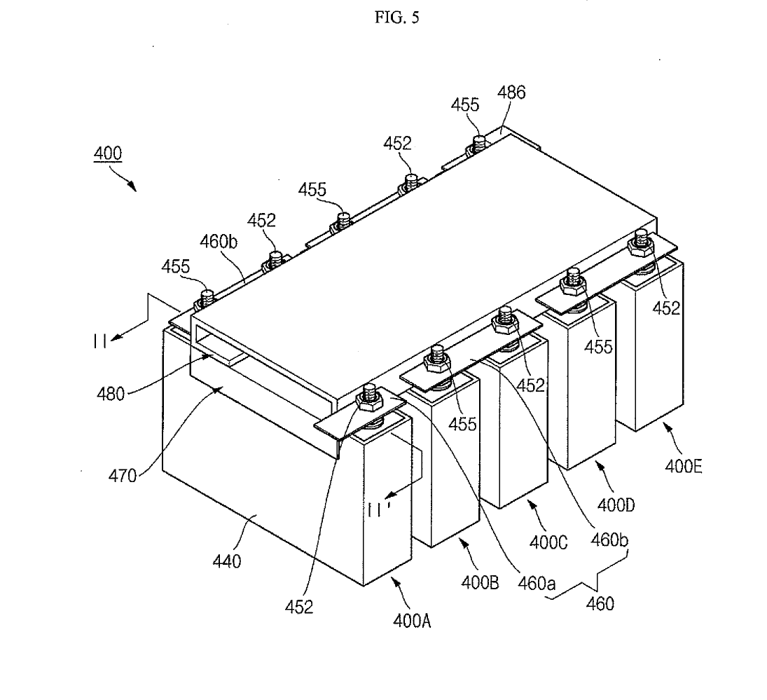

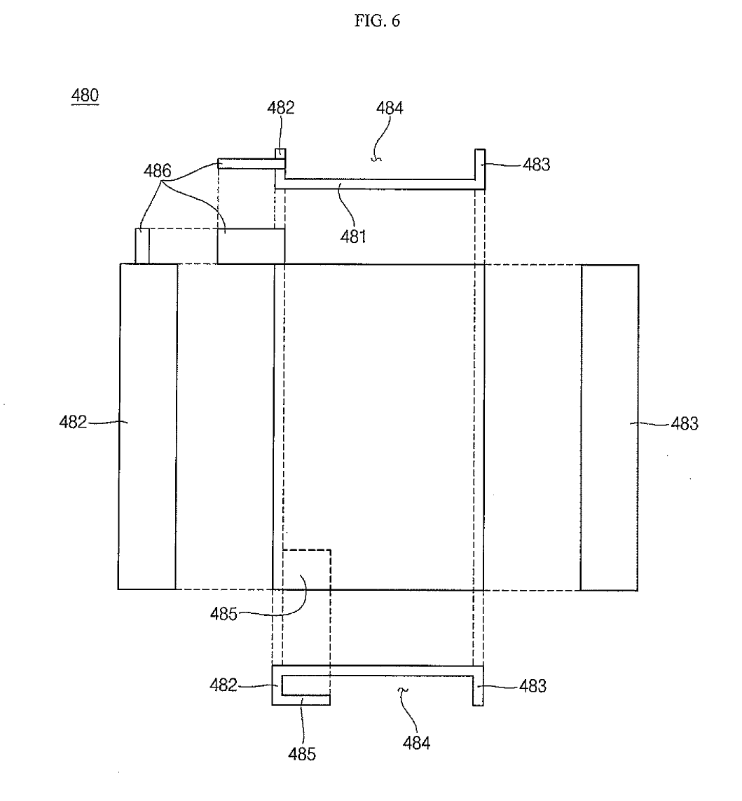

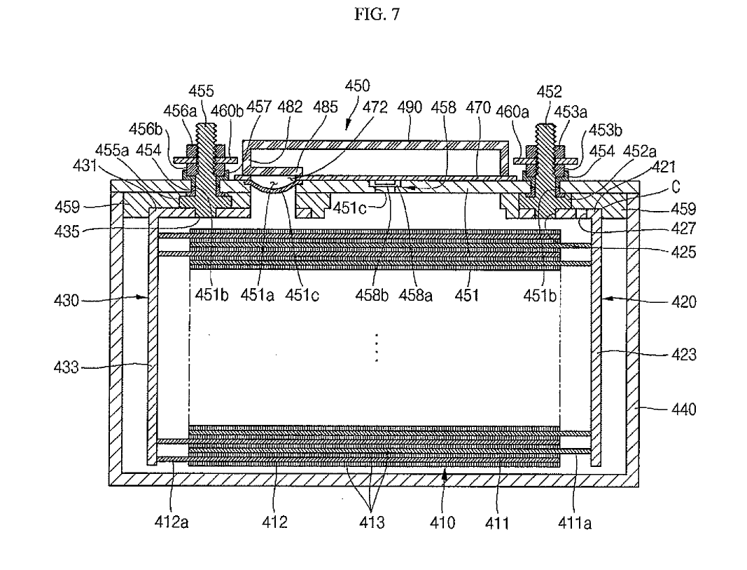

FIG. 5 is a perspective view illustrating a connection mechanism of the secondary battery module shown in FIG. 4, FIG. 6 illustrates a top surface, a front surface, a rear surface, a left side surface, and a right side surface of a second connection member shown in FIG. 4, and FIG. 7 is a cross-sectional view of the secondary battery module, taken along the line II-II′ of FIG. 5.

Referring to FIGS. 5 to 7, the secondary battery module 400 according to another embodiment of the present invention includes a plurality of secondary batteries, first connection members 460, and a second connection member 480. The secondary battery module 400 may further include an insulation film 470.

The plurality of secondary batteries may include first to fifth unit cells 400A, 400B, 400C, 400D, and 400E arranged in parallel to each other. The unit cells 400A, 400B, 400C, 400D, and 400E according to another embodiment of the present invention and the unit cells 100A, 100B, 100C, 100D and 100E according to a previously described embodiment of the present invention are differently labeled but are substantially the same or the same as each other in view of configurations. Therefore, detailed descriptions of the unit cells 400A, 400B, 400C, 400D, and 400E will be substituted by those of the unit cells 100A, 100B, 100C, 100D and 100E and will not be further given.

In addition, the insulation film 470 according to another embodiment of the present invention and the insulation film 170 according to a previously described embodiment of the present invention are differently labeled but are substantially similar or the same with each other in view of configurations. Therefore, a detailed description of the insulation film 470 will be substituted by that of the insulation film 170.

However, the secondary battery module according to another embodiment of the present invention is different from that according to a previously described embodiment of the present invention as follows.

In the secondary battery module according to another embodiment of the present invention, the second connection member 180 and the gas guiding member 190 according to a previously described embodiment of the present invention, are combined into a second connection member 480 made of a conductive material. Thus, the following description of the current embodiment will focus on configurations of the second connection member 480.

The second connection member 480 may include first to third plates 481, 482, and 483, a short circuit plate 485, and a connection plate 486.

The first to third plates 481, 482, and 483 according to another embodiment of the present invention are similar to the first to third plates 191, 192, and 193 according to an a previously described embodiment in view of configurations. Therefore, detailed descriptions of the first to third plates 481, 482, and 483 will be substituted by those of the first to third plates 191, 192, and 193. Here, the second and third plates 482 and 483 form opposite sidewalls of the second connection member 480, and other opposite sidewalls of the second connection member 480 are opened to form an exhaust opening 484 (e.g., an exhaust hole) through which gases are exhausted, as shown in FIG. 4.

The short circuit plate 485 may be connected to a bottom end of the second plate 482 and may be formed to face a short circuit member 451c of the first unit cell 400A. Here, the second connection member 480 may be insulated from a case 440 of each of the first to fifth unit cells 400A, 400B, 400C, 400D, and 400E by the insulation film 470, and the short circuit plate 485 may be spaced from (e.g., spaced apart from) the short circuit member 451c by a thickness of the insulation film 470. However, because the short circuit plate 485 is formed to have a height (e.g., a predetermined height) from the short circuit member 451c, it can be sufficiently spaced from (e.g., spaced apart from) the short circuit member 451c. In this case, the short circuit member 451c should be designed to have an inverted height (e.g., a height when in an inverted state) greater than the height (e.g., the predetermined height) during the operation of the short circuit member 451c.

The connection plate 486 is connected to a sidewall of the other side of the second plate 482, is substantially vertically bent from the sidewall of the other side of the second plate 482, and extends toward the second electrode terminal 455 of the fifth unit cell 400E. The connection plate 486 may be connected to the second plate 482 at a position higher than the bottom surface of the second plate 482 (e.g., by a predetermined height). The connection plate 486 may be electrically coupled to (e.g., electrically connected to) the second electrode terminal 455 of the fifth unit cell 400E.

Next, an operation of the secondary battery module 400 according to another embodiment of the present invention during overcharge will now be described.

When overcharge occurs to the first to fifth unit cells 400A, 400B, 400C, 400D, and 400E, the internal pressure of each case of the first to fifth unit cells 400A, 400B, 400C, 400D, and 400E may increase due to gases generated from each electrode assembly of the first to fifth unit cells 400A, 400B, 400C, 400D, and 400E, and when the internal pressure exceeds a reference level (e.g., a predetermined level), the short circuit member 451c of the first unit cell 400A arranged at the first position is inverted (e.g., deforms) to protrude toward an upper portion of a cap plate 451. Here, the protruding short circuit member 451c is brought into electrical contact with the short circuit plate 485 of the second connection member 480, thereby electrically coupling (e.g., electrically connecting) the short circuit member 451c to the second electrode terminal 455 of the fifth unit cell 400E, arranged at the last position, through the second connection member 480.

When the secondary battery module 400 is normally charged, a current flows through the first to fifth unit cells 400A, 400B, 400C, 400D, and 400E sequentially from the first electrode terminal 452 of the first unit cell 400A, arranged at the first position, to the second electrode terminal 455 of the fifth unit cell 400E, arranged at the last position. However, when the secondary battery module 400 is overcharged, the flow of an over-current is bypassed through the first electrode terminal 452 of the first unit cell 400A, arranged at the first position, to the case 440 of the first unit cell 400A, to the short circuit member 451c, to the second connection member 480, and then to the second electrode terminal 455 of the fifth unit cell 400E, arranged at the last position. Accordingly, only a fuse 427 of the first unit cell 400A is melted and severed, thereby preventing the secondary battery module 400 from being electrically coupled to (e.g. electrically connected to) an external device.

When overcharge occurs in a state in which the second connection member 480 is not provided, such as in a comparative secondary battery module, the over-current flows until one of the fuses of the first to fifth unit cells 400A, 400B, 400C, 400D, and 400E melts and is severed. In this case, even if there are unit cells whose fuses are not cut, short circuit members corresponding to these unit cells may partially operate and at least portions of the fuses may melt, such that the unit cell is severely damaged so as not to be recyclable or reusable.

However, according to this embodiment of the present invention, during overcharge, an over-current does not flow through the second to fifth unit cells 400B, 400C, 400D, and 400E; the over-current only flows through the first unit cell 400A, arranged at the first position, thereby preventing the other unit cells from being unnecessarily damaged.

In addition, during overcharge, the over-current is bypassed, so that a safety device, such as a short circuit member, is not necessarily provided in a unit cell or unit cells through which the over-current does not flow. Accordingly, the component cost of the secondary battery module may be reduced. In addition, because the short circuit member is not provided, it is possible to nullify a probability of moisture penetration into a portion at which the short circuit member is installed. Further, in a case where the short circuit member is installed, moisture penetration into the portion of the short circuit member may be reduced or minimized by the insulation film 470.

In addition, in the secondary battery module according to this embodiment of the present invention, the second connection member 180 and the gas guiding member 190 according to the embodiment of the present invention are combined as the second connection member 480, thereby simplifying mechanical construction and reducing the number of components of the secondary battery module.

Example embodiments of the present invention have been disclosed herein, and although specific terms are employed, they are used and are to be interpreted in a generic and descriptive sense and not for purpose of limitation. Accordingly, it will be understood by those of ordinary skill in the art that various changes in form and details may be made without departing from the spirit and scope of the present disclosure as set forth in the following claims and their equivalents.

What is claimed is:

1. A secondary battery module comprising:
a plurality of secondary batteries arranged in parallel with each other, each of the plurality of secondary batteries comprising an electrode assembly, a case accommodating the electrode assembly, first and second electrode terminals electrically coupled to the electrode assembly, and a short circuit member electrically coupled to the first electrode terminal and configured to protrude towards outside of the case when an internal pressure in the case increases;
a plurality of first connection members coupling the plurality of secondary batteries to each other in series; and
a second connection member having one side facing a short circuit member of one of the plurality of secondary batteries and an other side electrically coupled to a second electrode terminal of a secondary battery arranged at a last position from among the plurality of secondary batteries.

2. The secondary battery module as claimed in claim 1, further comprising an insulation film covering top surfaces of the plurality of secondary batteries and having an opening above the short circuit member.

3. The secondary battery module as claimed in claim 2, wherein each of the plurality of secondary batteries further comprises a safety vent covered by the insulation film and configured to open when the internal pressure in the case increases.

4. The secondary battery module as claimed in claim 3, wherein when the safety vent opens, the insulation film is ruptured by the safety vent to be open.

5. The secondary battery module as claimed in claim 1, further comprising a gas guiding member on the plurality of secondary batteries and configured to guide gases exhausted from the plurality of secondary batteries.

6. The secondary battery module as claimed in claim 5, wherein the gas guiding member comprises a first plate facing and spaced from top surfaces of the plurality of secondary batteries, and a second plate and a third plate extend from opposite side ends of the first plate and are between the first and second electrode terminals of the plurality of secondary batteries, and other opposite sidewalls of the gas guiding member are open.

7. The secondary battery module as claimed in claim 5, wherein the gas guiding member comprises an insulating material.

8. The secondary battery module as claimed in claim 1, wherein the short circuit member is configured to deform to contact one side of the second connection member when the internal pressure in the case increases.

9. The secondary battery module as claimed in claim 1, further comprising a fuse electrically coupling the electrode assembly and the first electrode terminal.

10. The secondary battery module as claimed in claim 1, wherein the short circuit member is at a secondary battery arranged at a first position from among the plurality of secondary batteries.

11. A secondary battery module comprising:
a plurality of secondary batteries arranged in parallel, each of the plurality of secondary batteries comprising an electrode assembly, a case accommodating the electrode assembly, first and second electrode terminals electrically coupled to the electrode assembly, and a short circuit member electrically coupled to the first electrode terminal and configured to protrude toward outside of the case when an internal pressure in the case increases;
a plurality of first connection members coupling the plurality of secondary batteries to each other in series; and
a second connection member on the plurality of secondary batteries and comprising a short circuit plate facing a short circuit member of one of the plurality of secondary batteries, a connection plate electrically coupled to a second electrode terminal of a secondary battery arranged at a last position from among the plurality of secondary batteries, and a gas guiding member configured to guide gases exhausted from the plurality of secondary batteries.

12. The secondary battery module as claimed in claim 11, further comprising an insulation film covering top surfaces of the plurality of secondary batteries and having an opening above the short circuit member.

13. The secondary battery module as claimed in claim 12, wherein each of the plurality of secondary batteries further comprises a safety vent covered by the insulation film and configured to open when the internal pressure in the case increases.

14. The secondary battery module as claimed in claim 13, wherein the insulation film is configured to be ruptured by the safety vent to be open when the safety vent opens.

15. The secondary battery module as claimed in claim 11, wherein the gas guiding member comprises a first plate facing and spaced from top surfaces of the plurality of secondary batteries, and a second plate and a third plate extending from opposite side ends of the first plate and between the first and second electrode terminals of the plurality of secondary batteries, and other opposite sidewalls of the gas guiding member are open.

16. The secondary battery module as claimed in claim 15, further comprising an insulation member between each bottom surface of the second plate and the third plate and each of the top surfaces of the plurality of secondary batteries.

17. The secondary battery module as claimed in claim 15, wherein the short circuit plate and the connection plate are coupled to the second plate or the third plate.

18. The secondary battery module as claimed in claim 11, wherein when the internal pressure in the case increases, the short circuit member deforms to contact one side of the short circuit plate.

19. The secondary battery module as claimed in claim 11, further comprising a fuse electrically coupling the electrode assembly and the first electrode terminal.

20. The secondary battery module as claimed in claim 11, wherein the short circuit member is at a secondary battery arranged at a first position from among the plurality of secondary batteries.
